(19) United States
(12) Patent Application Publication
(10) Pub. No.: US 2010/0279580 A1
(43) Pub. Date: Nov. 4, 2010

(54) DUAL BINDING CHILDREN'S ENTERTAINMENT DEVICE

(75) Inventor: Robert Sanford, Chippewa Lake, OH (US)

Correspondence Address: GODFREY & KAHN S.C., 780 NORTH WATER STREET, MILWAUKEE, WI, 53202, US

(73) Assignee: SCHOOL SPECIALTY INC., Appleton, WI (US)

(21) Appl. No.: 12/434,461

(22) Filed: May 1, 2009

(51) Int. Cl. A63H 33/38; B42D 1/00

(52) U.S. Cl. 446/147; 281/27.3

(57) ABSTRACT

An entertainment center for children or other users with a durable backer and two sets of pages bound to the backer along opposite sides. The pages and the backer may provide erasable writing surfaces where markers, pencils, crayons or other writing utensils may be used and then erased to permit future use of the same writing or drawing surface. The sets of pages are bound to the backer along opposite sides so that an inner edges of each set is positioned adjacent each other in a closed position and a locking mechanism is provided to retain the pages in the closed position. A durable cover may be provided in each set of pages.

### BACKGROUND

Books and other entertainment devices for children have included durable sheets permitting use of dry-erase or similar markers. Such devices provide for easy cleaning and reuse of the devices and permit a child to have access to a full array of colored markers or other drawing implements. It is also known to have such devices include pages and backers that are usable with static cling, magnetic backed or other types of stickers. These stickers may be removed from the pages and reused as well.

It is also known to provide a variety of pre-drawn outlines or other images on the pages or backers of such devices to provide a child with some guidance for creating and coloring their own drawings.

Improvements to conventional entertainment devices are desirable.

### SUMMARY

The present invention provides an entertainment center for children or other users with a durable backer and two sets of pages bound to the backer along opposite sides. The pages and the backer may provide erasable writing surfaces where markers, pencils, crayons or other writing utensils may be used and then erased to permit future use of the same writing or drawing surface. The sets of pages are bound to the backer along opposite sides so that an inner edges of each set is positioned adjacent each other in a closed position and a locking mechanism is provided to retain the pages in the closed position. A durable cover may be provided in each set of pages.

### BRIEF DESCRIPTION OF THE DRAWINGS

The accompanying drawing figures, which are incorporated in and constitute a part of the description, illustrate several aspects of the invention and together with the description, serve to explain the principles of the invention. A brief description of the figures is as follows:

FIG. 1 is a perspective view of an entertainment device according to the present disclosure.

FIG. 2 is an exploded layout illustrating the various elements of the device of FIG. 1.

### DETAILED DESCRIPTION

Reference will now be made in detail to exemplary aspects of the present invention which are illustrated in the accompanying drawings. Wherever possible, the same reference numbers will be used throughout the drawings to refer to the same or like parts.

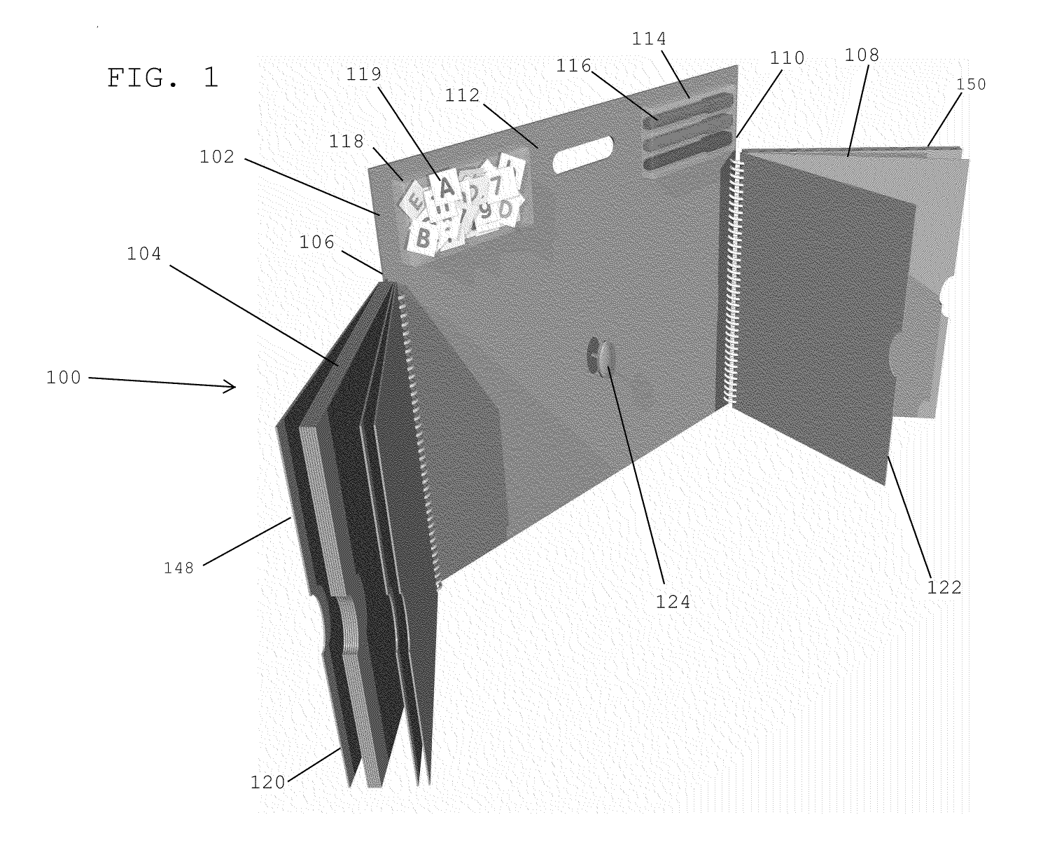

FIG. 1 illustrates an entertainment center or device 100 according to the present disclosure. Device 100 may include a first plurality of pages 102 bound to a backer 104 along a first side or edge 106 and a second plurality of pages 108 bound to backer 104 along a second opposite side or edge 110. A header portion 112 of backer 104 may extend above the top of the pages 102 and 108. This header portion may include one or more storage areas 114 for storing and keeping markers or other drawing implements 116 with device 100. An additional storage area 118 may be provided to store and keep stickers or other reusable adhesive objects 119 with device 100. The pages and the backer are preferably made of a suitable material to provide a durable surface that permits marks from markers, pencils or other writing utensils to be erased so that the pages and backer may be used multiple times to create artwork by a user. The overall material from the pages or the backer are made may provide this surface quality or they may be coated or laminated with a suitable surface material.

Situated between inner edges 120 of pages 102 and inner edges 122 of pages 108 may be a reclosable retaining device or locking mechanism 124. Locking mechanism 124 has an open position, where the inner edges 120, 122 may pass by the locking mechanism, and a locked position, wherein the inner edges are interfered with as they pass by the locking mechanism. Heavier weight outer pages or covers 148, associated with pages 102 and 150, associated with pages 108, may be included to provide a more durable and rugged outer surface to protect the underlying pages and also provide a for more secure closure of the device when locking mechanism 124 is engaged. These heavier weight outer pages may also provide some underlying structural support to the associated pages when the device is used in a position other than flat on a table, floor or desktop.

The pages 102, 108 of device 100 are movable between open and closed positions. In the closed position, the inner edges of the pages lie against backer 104 adjacent locking mechanism 124. As shown in FIG. 1, the pages are in a partially open position. Within the scope of the present disclosure, it is preferable that the attachment of the pages to the backer will permit the pages to move to a fully opened position with the covers lying parallel to backer 104 but with their inner edges positioned away from the locking mechanism.

It is anticipated that the pages 102, 108 within the first and second pluralities will include coordinated or thematic consistent materials. For example, device 100 may include pages with a zoo theme, a race track theme, an underwater theme, a pirate theme, or any other suitable theme. The pages bound on the opposite sides of backer 104 may include halves of a continuous drawing, or at least their images coordinated together. The innermost page of each side may include a portion of a drawing that is also continuous across the backer behind the pages. Thus, when the last pages of each side are fully opened and laid flat, there may be a continuous drawing stretching across both innermost pages and the backer. Similarly, when all the pages are in the closed position, a continuous image may be provided across the two pages.

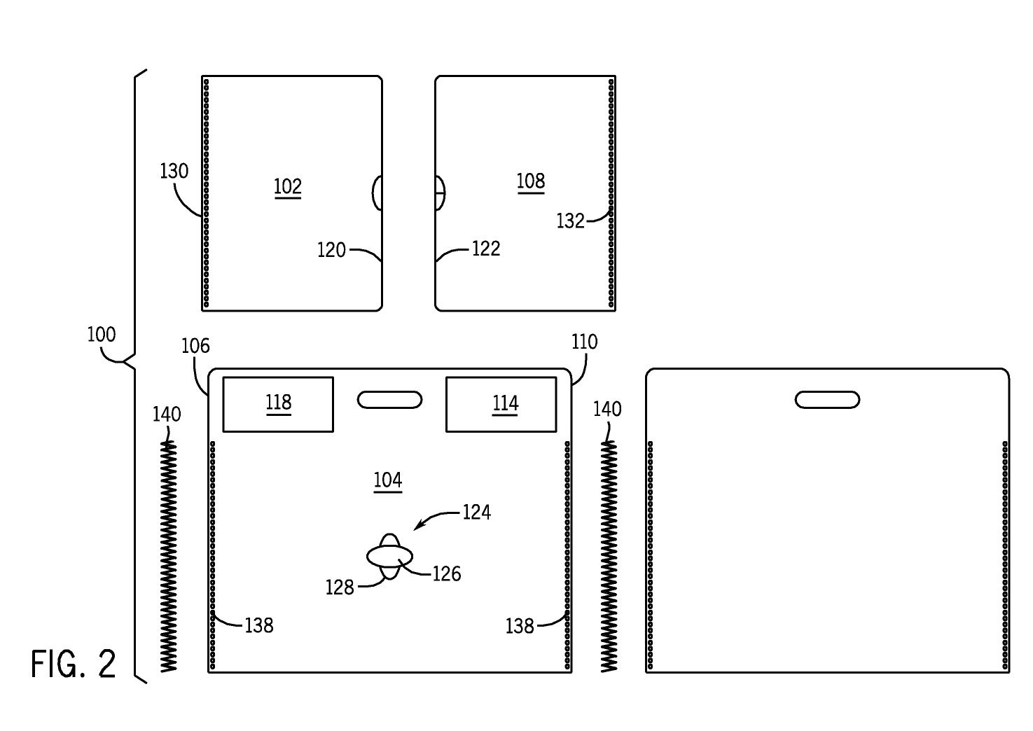

Referring now to FIG. 2, the various elements of device 100 are illustrated separate from each other for clarity. As shown, in a preferred embodiment, locking mechanism 124 includes a fixed or offset portion 128 and a pivoting portion 126, which is pivotably mounted to the fixed portion. In this embodiment, the pivoting portion 126 has opposed wings. Since a plurality of pages 102 and 108 may be included in device 100, a topmost of these pages will be offset above backer 104 to which the pages and locking mechanism 124 are attached. Offset portion 128 may be selected to position pivoting portion 126 at a sufficient height above backer 104 to permit pivoting portion 126 to be pivoted so that the wings are positioned over the pages along the inner edges 120 and 122, so that the pages are retained by the pivoting portion. In the most preferred embodiment, pivoting portion 126 may be provided with a first detent, biasing the pivoting portion toward the locked position. Pivoting portion 126 may also be provided with a second detent, biasing the pivoting portion toward the unlocked position, and the second detent may be, but is not required to be, in addition to the first detent. Since pages 102 and 106 are bound to backer 104 along outer edges 130 and 132, respectively, the use of a single centrally located locking mechanism 124 should be sufficient to retain the pages in a closed position. It is anticipated that a plurality of locking mechanisms may be used with the scope of the present disclosure, such as but not limited to an upper and lower mechanism engaging the pages along the inner edges or at least one locking mechanism separately engaging each of the pluralities 102, 108 of pages.

Backer 104 may be preferably made of a generally rigid or stiff material so that device 100 may be leaned or placed against another object as opposed to lying flat on a floor or tabletop. Suitable materials for backer 104 may include but are not limited to cardboard, pressboard, wood, engineered or processed wood products, plastic, corrugated sheets, and other suitable materials. Along outer edges adjacent first and second sides 106 and 110 may be located binding areas 138 for attaching pages 104 and 108. As shown, binding areas 138 are configured to support spiral binding of pages 104 and 108 to backer 104. It is anticipated that other binding techniques may be used within the scope of the present disclosure, including but not limited to sewn bindings, perfect binding, comb binding, or other suitable methods that may permit easy, repeated turning of the pages and which may also facilitate the pages lying flat when open.

A pair of spiral bindings 140 are shown in FIG. 2 adjacent binding areas 138. Binding areas 138 each include openings to permit bindings 140 to be inserted. Pages 104 and 108 include corresponding openings to permit the insertion of the bindings as well. Where other binding methods are used, it is anticipated that binding area 138 as well as the corresponding sides of pages 104 and 108 will be altered as needed to accommodate the binding method.

While the invention has been described with reference to preferred embodiments, it is to be understood that the invention is not intended to be limited to the specific embodiments set forth above. It is recognized that those skilled in the art will appreciate that certain substitutions, alterations, modifications, and omissions may be made without departing from the spirit or intent of the invention. Accordingly, the foregoing description is meant to be exemplary only, and should not limit the scope of the invention set forth in the following claims. Further, the invention is to be taken as including all reasonable equivalents to the subject matter of the claims.

What is claimed is:

1. An entertainment device comprising:
a backer having first and second opposing sides with a binding space defined adjacent to each of the first and second sides, the backer made of a rigid material to provide structure for the device;
a first plurality of pages with an inner edge and an outer edge, the outer edge of the first plurality of pages attached to the first side of the backer by a binding;
a second plurality of pages with an inner edge and an outer edge, the outer edge of the second plurality of pages attached to the second side of the backer by a binding;
the pages and the backer made of materials that provide a durable surface configured for use with erasable writing utensils;
wherein the inner edges of the first and second pluralities of pages lie adjacent each other when the pages are in a closed position and the pages are movable to an open position; and,
a locking mechanism to releasably retain the pages in the closed position.

2. The entertainment device of claim 1, further comprising the pages bound to the binding areas of the backer by a spiral binding.

3. The entertainment device of claim 1, further comprising pages in the first plurality corresponding to pages in the second plurality and having coordinated images so that when the corresponding pages are in the closed position, a continuous image is provided across the two pages.

4. The entertainment device of claim 1, further comprising a cover in each plurality of pages, the cover made of a durable material to provide support for the pages in the open position and configured to engage the locking mechanism in the closed position.

5. The entertainment device of claim 1, further comprising a header defined on the backer above the pages with at least one storage area positioned in the header with writing utensils for erasably marking on the pages and the backer.

6. The entertainment device of claim 5, further comprising two storage areas positioned in the backer, with one storage area including writing utensils and another storage area including stickers for removable placement on the backer and pages.

7. An entertainment device comprising:
a backer made of a rigid material and having first and second opposing edges;
a first plurality of pages with an inner edge and an outer edge, the outer edge of the first plurality of pages attached to the first edge of the backer;
a second plurality of pages with an inner edge and an outer edge, the outer edge of the second plurality of pages attached to the second edge of the backer;
wherein the first and second pluralities of pages have a closed position and are movable to an open position; and,
a locking mechanism to releasably retain the pages in the closed position.

8. The entertainment device of claim 7 wherein the inner edges of the first and second pluralities of pages lie adjacent each other when the pages are in the closed position.

9. The entertainment device of claim 7 wherein the backer has a binding space defined adjacent to each of the first and second edges of the backer, and
the first plurality of pages is attached to the first edge of the backer by a binding; and
the second plurality of pages is attached to the second edge of the backer by a binding.

10. The entertainment device of claim 7 wherein the backer is made of a material that provide a durable surface configured -for use with erasable writing utensils.

11. The entertainment device of claim 7 wherein the pages and the backer made of materials that provide a durable surface configured for use with erasable writing utensils;

12. The entertainment device of claim 7, wherein the pages are bound to the binding areas of the backer by a spiral binding.

13. The entertainment device of claim 7, further comprising pages in the first plurality corresponding to pages in the second plurality and having coordinated images so that when the corresponding pages are in the closed position, a continuous image is provided across the two pages.

14. The entertainment device of claim 7, further comprising a cover in each plurality of pages, the cover made of a durable material to provide support for the pages in the open position and configured to engage the locking mechanism in the closed position.

15. The entertainment device of claim 7, further comprising a header defined on the backer above the pages with at least one storage area positioned in the header with writing utensils for erasably marking on the pages and the backer.

16. The entertainment device of claim 15, further comprising a plurality of storage areas positioned in the backer, with at least one storage area including writing utensils and at least one storage area including stickers for removable placement on the backer and pages.
